(19) United States
(12) Patent Application Publication
(10) Pub. No.: US 2013/0050195 A1
(43) Pub. Date: Feb. 28, 2013

(54) LIQUID CRYSTAL DISPLAY DEVICE

(71) Applicants: Hung-Lung Hou, Guangdong (CN); Cheng-ming He, Guangdong (CN)

(72) Inventors: Hung-Lung Hou, Guangdong (CN); Cheng-ming He, Guangdong (CN)

(73) Assignee: SHENZHEN CHINA STAR OPTOELECTRONICS TECHNOLOGY CO., LTD., Shenzhen (CN)

(21) Appl. No.: 13/376,177

(22) PCT Filed: Nov. 1, 2011
(86) PCT No.: PCT/CN2011/081612

§ 371 Date: Dec. 2, 2011

(30) Foreign Application Priority Data
Aug. 31, 2011 (CN) 201110254725.X

(51) Int. Cl. G06T 15/00

(52) U.S. Cl. 345/419

(57) ABSTRACT

The present invention provides a liquid crystal display device, which comprises a TFT-LCD module. The TFT-LCD module comprises pixels, data lines and first switches which control the pixels to be switched on; each of the pixels comprises a main-pixel and a sub-pixel. The TFT-LCD module further comprises a pair of pixel capacitors and second switches; the TFT-LCD module further comprises third switches, each of which is used to control the main-pixel and the sub-pixel to be switched on. This invention may achieve the effect to reduce the crosstalk phenomenon generated when watching a 3D image and the brightness decay generated when watching a 2D image by controlling the main-pixel or the sub-pixel to be switched on.

### FIELD OF THE INVENTION

The present invention relates to a scope of a liquid crystal display device, and more particularly to a liquid crystal display device capable of reducing crosstalk phenomenon between pixels without affecting the 2D (two-dimensional) display quality of a display device.

### BACKGROUND OF THE INVENTION

With the development of the 3D (three-dimensional) technology, people have higher and higher requests in watching 3D movies by a 3D display device. A cross-section of a common glasses-type 3D liquid crystal display device is shown in FIG. 1, which comprises a TFT-LCD (Thin Film Transistor-Liquid Crystal Display) module 110 and a phase retarder 120. The TFT-LCD module 110 comprises a TFT substrate 111, and a CF (Color Filter) substrate 130 is disposed between the TFT-LCD module 110 and the phase retarder 120. The TFT substrate 111 has a transparent TFT circuit thereon, and the CF substrate 130 has a plurality of filter units of RGB (Red, Green and Blue) three primary colors. Pixel signals of this type of the 3D liquid crystal display device from top to bottom are a cycle of left-eye signals and right-eye signals, respectively, so that light signals of the display device are received by a left eye and a right eye in a horizontal and up-down alternate way, as shown in FIG. 2.

A front side of the TFT-LCD module 110 is attached with the phase retarder 120. According to the pixel signals of the display device, which in the cycle of the left-eye and right-eye signals from top to bottom, different phase compensation values are given to the left eye and the right eye by phase arrangements of the phase retarder 120, respectively, so that the left-eye and right-eye signals with the same vertical-polarization state, which are emitted from the TFT-LCD module 110, are converted into different polarized lights between the left eye and the right eye. As shown in FIG. 1, supposing that a polarization state of lights emitted from the TFT-LCD module 110 is the vertical-polarization state, pixel signals for the right eye pass through a λ/2-phase filter and transform into a horizontal polarization, and pixel signals for the left eye pass through a 0-phase filter and keep the vertical-polarization state. Then, the left-eye and right-eye signals can be distinguished by polarized glasses.

But, there is a shortcoming to the design in FIG. 1, that is a limitation of watching in a large and vertical viewing angle. The viewing angle may not exceed ±θ1 If the viewing angle exceeds ±θ1, the pixel signals for the left eye pass through the λ/2-phase filter and the pixel signals for the right eye pass through the 0-phase filter, so that the left eye which originally receives the left-eye signals by the vertical-polarization of the left eye also receives the vertical right-eye signals which come from the right-eye pixel signals passed through the 0-phase filter due to a large viewing angle; the right eye which originally receives the right-eye signals by the horizontal-polarization of the right eye also receives the horizontal left-eye signals which come from the left-eye pixel signals passed through the λ/2-phase filter due to the large viewing angle. It thus generates so-called crosstalk phenomenon, which means that high contrast profiles of images generate drag phenomena in a background.

FIG. 3 is a way to improve the crosstalk phenomenon of the liquid crystal display device, which designs a black matrix on the original CF substrate 130, so that originally available diameters of the λ/2-phase filter and the 0-phase filter are narrowed down from “a” to “b”. Thus, the angle of the left-eye and right-eye signals passing through the corresponding phase retarder 120 is larger angle in a case of large viewing angle, so as to increase a viewing angle which will not generate the crosstalk phenomenon. However, when using the liquid crystal display device to watch a 2D image, the black matrix existing on the CF substrate 130 may cause of lowering the brightness during the liquid crystal display device displays the 2D image.

FIGS. 4 and 5 show another way to improve the crosstalk phenomenon of the liquid crystal display device, which changes a range of light-emitting regions of the pixels. This needs to use two data lines or two scan lines to individually control gray-scale signals and black-matrix signals of the pixels for separating the gray-scale signals from the black-matrix singles. Thus, because of the pixel signals emitted from the TFT-LCD module 110 comprise the black-matrix signals, it also can achieve the target of increasing time for watching the left-eye signals or the right-eye signals with the large viewing angle and then decreasing the crosstalk phenomenon between the pixels.

But, in the way, because of adopting double data lines or scan lines, the cost of driving chips may increase, and this way can not be applied to perform a CS display mode (charging sharing, charge-discharge display mode) of main-pixel areas and sub-pixel areas by a capacitor to charge and discharge. In the liquid crystal display device 600 as shown in FIG. 6, a voltage of the main-pixels 620 and a voltage of the sub-pixels 630 are determined by the separately connected pixel capacitor (not shown in Figs.) in the CS display mode. Thus, in a situation of the ensured pixel capacitor, the voltage of the main-pixels 620 and the voltage of the sub-pixels 630 have a voltage-relationship, so that the main-pixels 620 may display main-gray-scale signals when the pixels display a high gray-scale and the sub-pixels 630 will also get brightened and cannot keep black because of displaying sub-gray-scale signals (which have a certain proportion to the main-gray-scale signals and less than the main-gray-scale signals). It causes that the real black-matrix signal cannot be generated during the 3D displaying.

Thus, it is necessary to provide a liquid crystal display device for solving the appearance problems in the conventional technology.

### SUMMARY OF THE INVENTION

An object of the present invention is to provide a liquid crystal display device for solving the problems of the liquid crystal display device in the conventional technology, which the crosstalk phenomenon is easier induced to affect display quality when watching a 3D image or reducing brightness when watching a 2D image.

For solving the above problems, this present inventor provides technical solutions, as follows:

A liquid crystal display device, comprises: pixels used to display gray-scale signals in an image, data lines used to transmit data signals to the pixels, and first switches used to control the pixels to be switched on; each of the pixels comprises a main-pixel used to display main-gray-scale signals and a sub-pixel used to display sub-gray-scale signals; the liquid crystal display device further comprises: a pair of pixel capacitors used to redistribute voltages of gray-scale signals of the main-pixel and the sub-pixel in the same image, and a second switch used to control the redistribution operation, wherein the liquid crystal display device further comprises a third switch used to control the sub-pixel to be switched on; the liquid crystal display device further comprises: a control unit which controls the third switch to be switched on, the control unit is connected to a control terminal of the third switch, an input terminal of the third switch is connected to a black-matrix signal, an output terminal of the third switch is connected to the sub-pixel; wherein when the liquid crystal display device is used to display a 3D image, the third switch is kept to be switched on; wherein when the liquid crystal display device is used to display a 2D image, the third switch is kept to be switched off; and the black-matrix signal is a common signal.

A liquid crystal display device, comprises: pixels used to display gray-scale signals in a image, data lines used to transmit data signals to the pixels, and first switches used to control the pixels to be switched on; each of the pixels comprises a main-pixel used to display main-gray-scale signals and a sub-pixel used to display sub-gray-scale signals; the liquid crystal display device further comprises: a pair of pixel capacitors used to redistribute voltages of gray-scale signals of the main-pixel and the sub-pixel in the same image and a second switch used to control the redistribution operation; the liquid crystal display device further comprises a third switch used to control the sub-pixel to be switched on.

In one embodiment of the present invention, the control terminal of the first switches is connected to scan lines, an input terminal of the first switch is connected to one of the data lines, and an output terminal of the first switch is connected to the main-pixel and the sub-pixel, respectively.

In one embodiment of the present invention, the liquid crystal display device further comprises: a control unit which controls the third switch to be switched on, the control unit is connected to a control terminal of the third switch, an input terminal of the third switch is connected to the black-matrix signal, and an output terminal of the third switch is connected to the sub-pixel.

In one embodiment of the present invention, when the liquid crystal display device is used to display a 3D image, the third switch is kept to be switched on.

In one embodiment of the present invention, when the liquid crystal display device is used to display a 2D image, the third switch is kept to be switched off.

In one embodiment of the present invention, the black-matrix signal is a common signal.

A liquid crystal display device, comprises: pixels used to display gray-scale signals in a image, data lines used to transmit data signals to the pixels, and first switches used to control the pixels to be switched on; each of the pixels comprises a main-pixel used to display main-gray-scale signals and a sub-pixel used to display sub-gray-scale signals; the liquid crystal display device further comprises: a pair of pixel capacitors used to redistribute voltages of gray-scale signals of the main-pixel and the sub-pixel in the same image and a second switch used to control the redistribution operation; the liquid crystal display device further comprises a third switch used to control the main-pixel to be switched on.

In one embodiment of the present invention, the control terminal of the first switch is connected to scan lines, an input terminal of the first switch is connected to one of data lines, and an output terminal of the first switch is connected to the main-pixel and the sub-pixel, respectively.

In one embodiment of the present invention, the liquid crystal display device further comprises: a control unit which controls the third switch to be switched on, the control unit is connected to a control terminal of the third switch, an input terminal of the third switch is connected to the black-matrix signal, and an output terminal of the third switch is connected to the main-pixel.

In one embodiment of the present invention, when the liquid crystal display device is used to display a 3D image, the third switch is kept to be switched on.

In one embodiment of the present invention, when the liquid crystal display device is used to display a 2D image, the third switch is kept to be switched off.

In one embodiment of the present invention, the black-matrix signal is a common signal.

Comparing with the crosstalk phenomenon is easier induced to affect display quality when watching a 3D image or reducing brightness when watching a 2D image to the traditional liquid crystal display device, the present invention of the liquid crystal display device can reach the performance of reducing the crosstalk phenomenon when watching the 3D image and no brightness decay when watching the 2D image by controlling the main-pixel or the sub-pixel to be switched on.

The foregoing contents adopted by the present invention can be best understood by referring to the following detailed description of the preferred embodiments and the accompanying drawings;

### DESCRIPTION OF THE DRAWINGS

FIG. 1 illustrates a schematic structure of a traditional liquid crystal display device;

FIG. 2 illustrates panel signals of the traditional liquid crystal display device;

FIG. 3 illustrates a schematic structural view of a black matrix set on a phase retarder of the traditional liquid crystal display device;

FIG. 4 illustrates a schematic structural view of a black-matrix signal set on image signals of the traditional liquid crystal display device;

FIG. 5 illustrates another schematic structural view of the black-matrix signal set on the image signals of the traditional liquid crystal display device;

FIG. 6 illustrates a structural view of a pixel driver of a CS display mode of the traditional liquid crystal display device;

FIG. 7 illustrates a schematic view of signal potentials of various signals in 2D displaying according to a preferred embodiment of a liquid crystal display device of the present invention;

FIG. 8 illustrates a schematic structural view of a pixel driver of a CS display mode according to a first preferred embodiment of a liquid crystal display device of the present invention;

FIG. 9 illustrates a schematic structural view of a circuit of the CS display mode according to the first preferred embodiment of the liquid crystal display device of the present invention;

FIG. 10 illustrates a schematic view of signal potentials of various signals in 3D displaying according to the first preferred embodiment of the liquid crystal display device of the present invention;

FIG. 11 illustrates a schematic structural view of a pixel driver of a CS display mode according to a second preferred embodiment of a liquid crystal display device of the present invention;

FIG. 12 illustrates a schematic structural view of a circuit of the CS display mode according to the second preferred embodiment of the liquid crystal display device of the present invention; and

FIG. 13 illustrates a schematic view of signal potentials of various signals in 3D displaying according to the second preferred embodiment of the liquid crystal display device of the present invention.

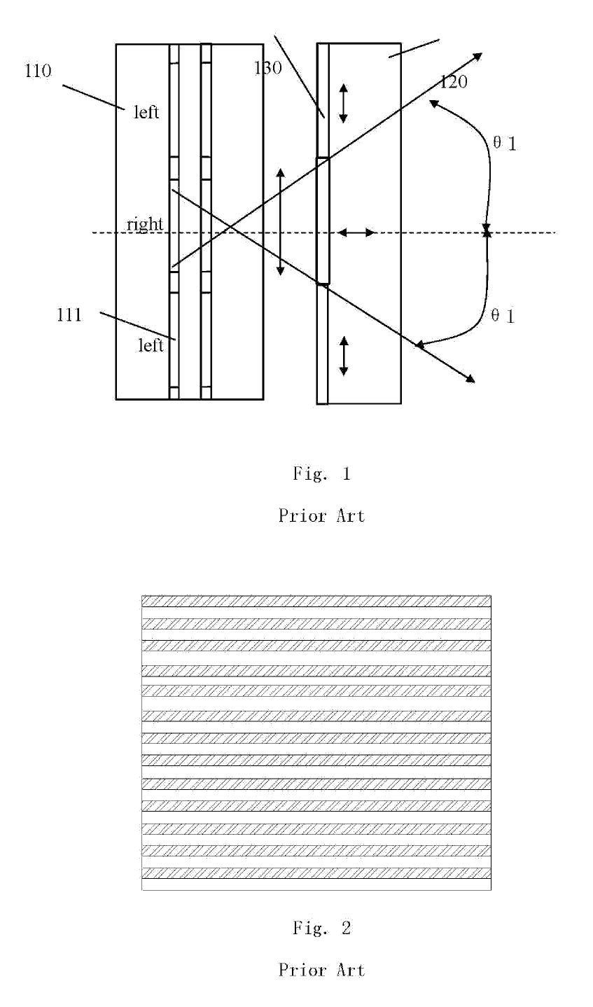

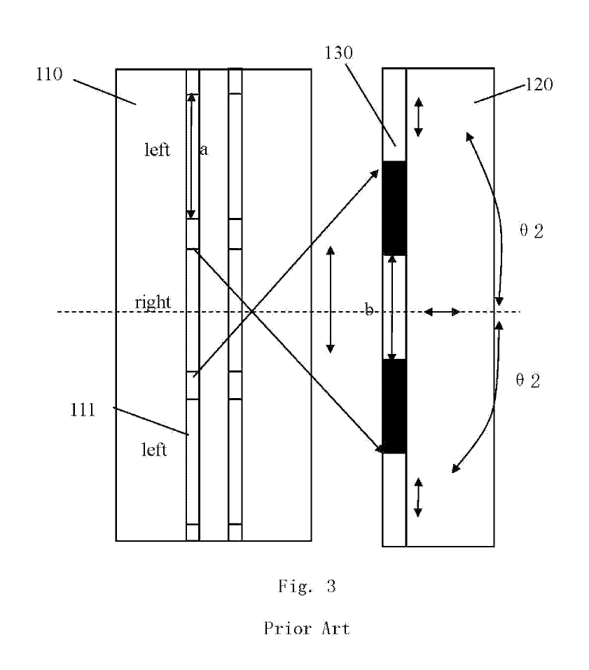

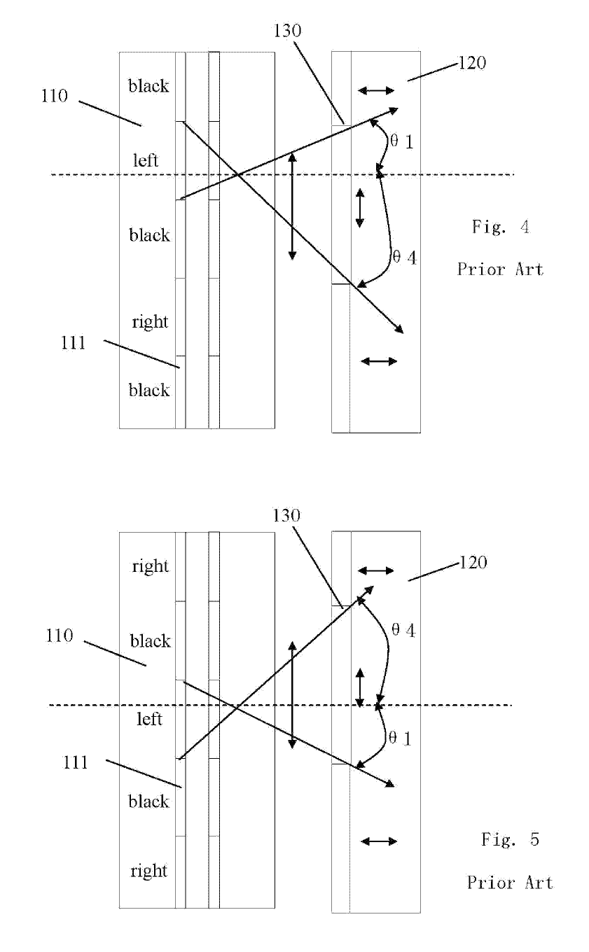

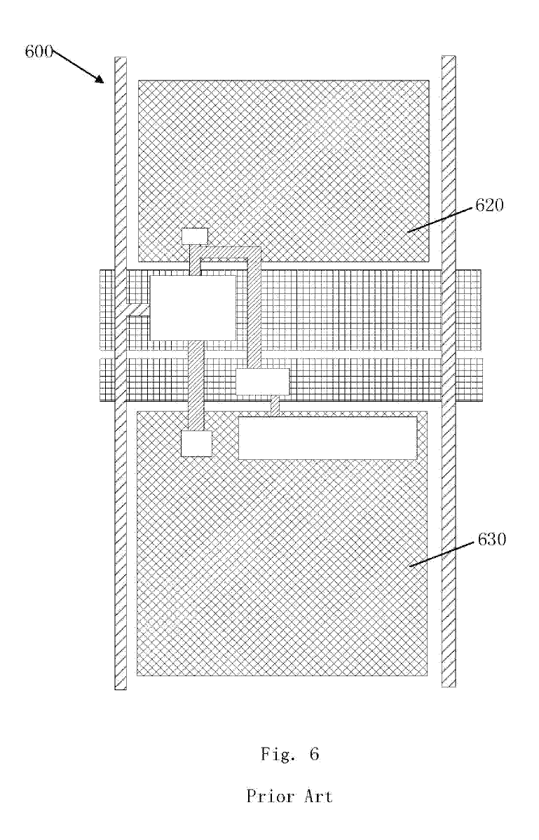

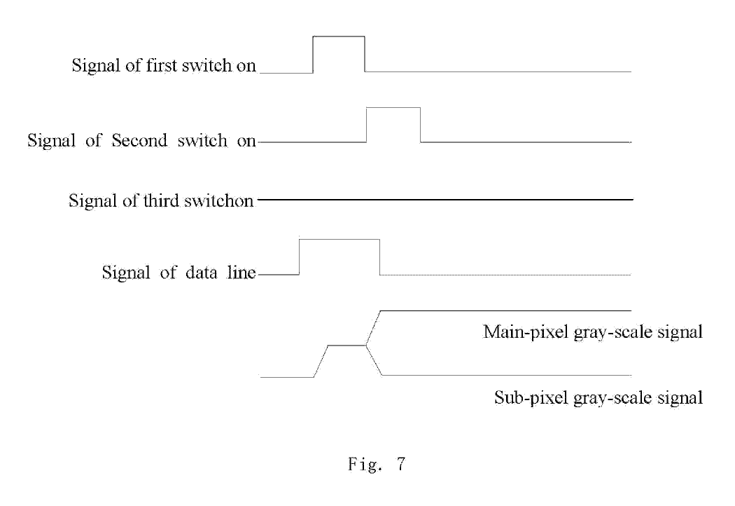

### DETAILED DESCRIPTION OF THE PREFERRED EMBODIMENTS

The foregoing description of embodiments is referring to the accompanying drawings for description of the specific embodiments which can be carried out in the present invention. The directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In Figs., the units with similar structures are used similar numerals.

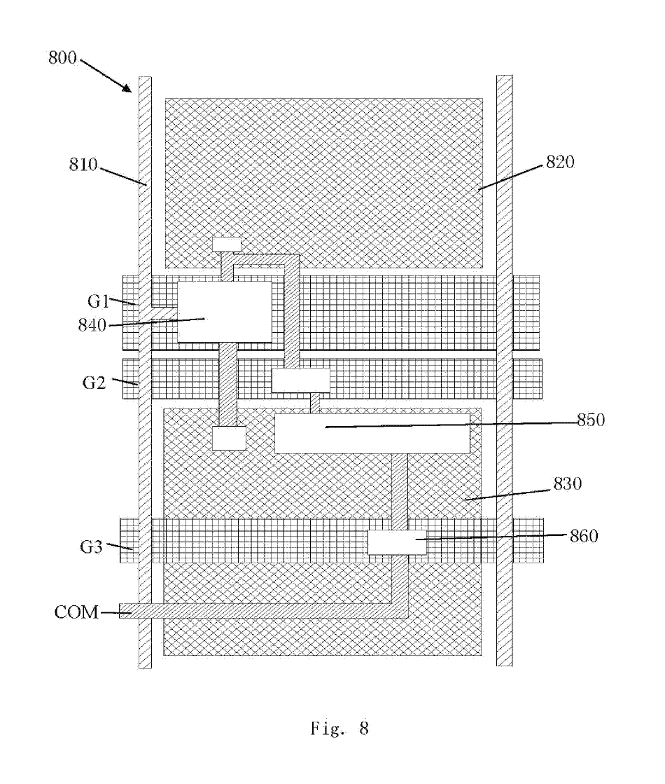

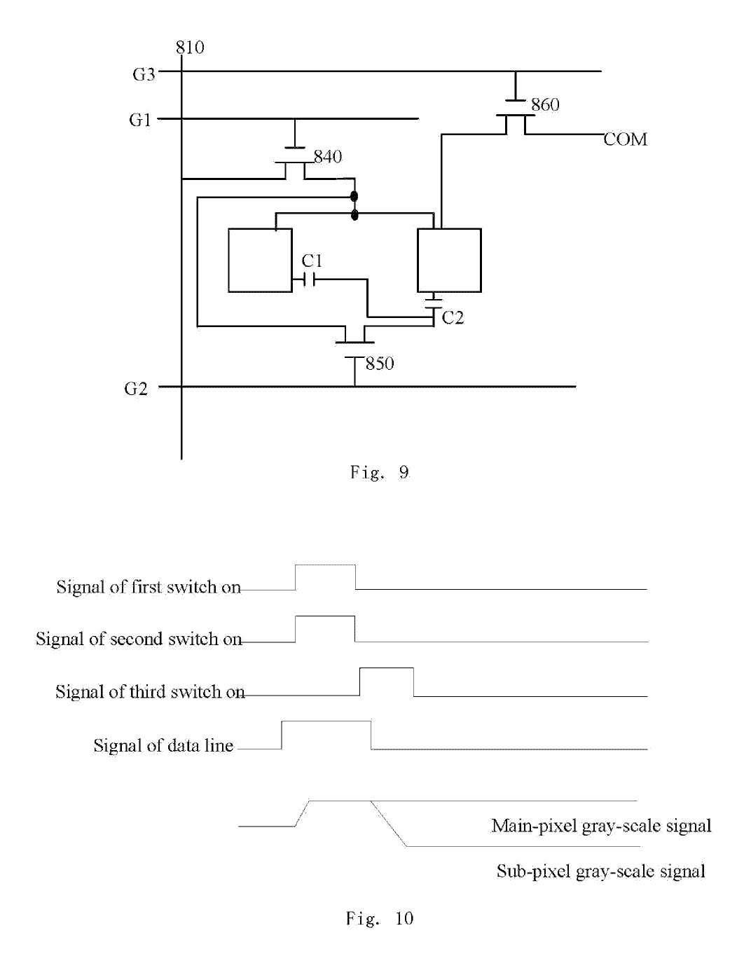

Referring to FIG. 8, which is a schematic structure of a pixel driver of a CS display mode of a first preferred embodiment of this present liquid crystal display device, and FIG. 9 is a schematic structure of a circuit of the liquid crystal display device. The liquid crystal display device 800 comprises pixels, data lines 810 and first switches 840. The pixels use to display gray-scale signals in an image, each of the data lines 810 is used to transmit data signals to each of the pixels, and each of the first switch 840 is used to control each of the pixels to be switched on. Each of the pixels comprises a main-pixel 820 used to display main-gray-scale signals and a sub-pixel 830 used to display sub-gray-scale signals. The liquid crystal display device 800 further comprises a pair of pixel capacitors C1 and C2 and second switches 850. When each of the second switches 850 is connected, the main-pixel 820 and the sub-pixel 830 are turned on by the pair of pixel capacitors C1 and C2, so that potentials of the main-pixel 820 and the sub-pixel 830 may redistribute in accordance with a ratio of values of the two capacitors. Finally, a voltage of the main-pixel 820 and a voltage of the sub-pixel 830 forms a voltage-relationship, and thus the two pixels attain different optical properties for performing a wide viewing angle in displaying.

For reducing the crosstalk phenomenon, the liquid crystal display device 800 of this invention further comprises a control unit (not shown in Figs.) and third switches 860, wherein each of the third switches 860 is used to control the sub-pixel 830 to be switched on. The liquid crystal display device further comprises what the control unit is connected to a control terminal of the third switch 860 via a scan line G3 for controlling the third switch 860 to be switched on. An input terminal of the third switch 860 is connected to a fixed voltage terminal, and an output terminal of the third switch 860 is connected to the sub-pixel 830. The fixed voltage terminal is used to provide a fixed voltage signal, and the best choice of the fixed voltage signal is a common signal (COM).

Please simultaneously refer to FIGS. 7, 8 and 9, when using the liquid crystal display device 800 of this invention to display a 2D image, because of having not to concern about the occurring crosstalk phenomenon, the third switch 860 has been cut off, and thus the fixed voltage signal may not be transmitted to the sub-pixel 830 via the third switch 860. During displaying the 2D image, the first switch 840 is on first (controlled by a scan line G1) for transmitting signals of the data line 810 to the main-pixel 820 and the sub-pixel 830, and then connecting the second switch 850 (controlled by a scan line G2); thus redistributing a driving voltage between the main-pixel 820 and the sub-pixel 830 by the corresponding pixel capacitors C1 and C2. An on-time of the first switch 840 is within a high voltage signal of the data line 810, and this may ensure that the 2D image signals can be normal displayed and the gray-scale signals of the main-pixel 820 and the gray-scale signals of the sub-pixel 830 show the different gray-scale-signal driving voltage in accordance with the pixel capacitors C1 and C2 for achieving a better performance in displaying. The main-pixel 820 and the sub-pixel 830 may normally display the 2D image as a traditional liquid crystal display device, so that the two pixels attain different optical properties for performing the wide viewing angle in displaying.

Please simultaneously refer to FIGS. 8, 9 and 10, when using the liquid crystal display device 800 of this invention to display a 3D image, the third switch 860 is kept to be switched on and the common signals may be transmitted to the sub-pixel 830 by the third switch 860. At this time, it is equal to produce a black-matrix signal at a position of the sub-pixel 830, and the black-matrix signal may not be affected by the gray-scale signals of the main-pixel 820 and may realize the black-matrix signal with whole black for really attaining the target in reducing the crosstalk phenomenon. During displaying the 3D image, when the data line 810 transmits 3D gray-scale signals, the first switch 840 and the second switch 850 are switched on, and the main-pixel 820 and the sub-pixel 830 normally display image signals. After the data line 810 transmitted the 3D gray-scale signals, the first switch 840 and the second switch 850 are cut off, and the third switch 860 is connected (controlled by the scan line G3). Thus, the sub-pixel 830 displays the black-matrix signal for realizing the black-matrix signal with whole black, which performs to the liquid crystal display device is what the sub-pixel 830 has appeared the dark state. By distinguishing the black-matrix signal and the gray-scale signals may reduce the crosstalk phenomenon, thus the liquid crystal display device 800 of this invention can be good in reducing the crosstalk phenomenon during displaying the 3D image and may not affect brightness during displaying the 2D image.

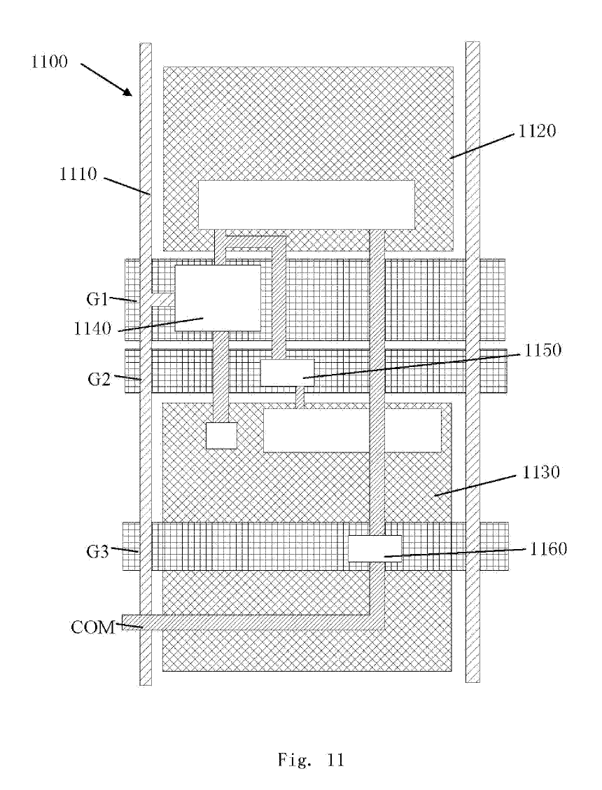

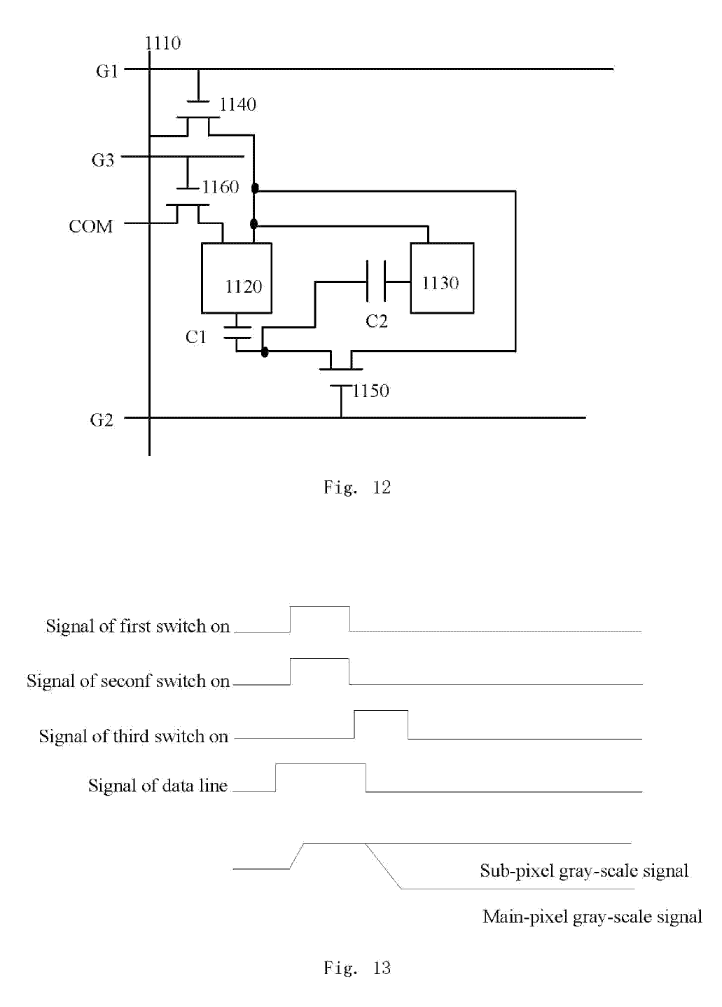

The present invention relates to a liquid crystal display device. Please refer to FIGS. 11 and 12. FIG. 11 illustrates a schematic structure of a pixel driver of a CS display mode of a second preferred embodiment of this present liquid crystal display device, and FIG. 12 is a schematic structure of a circuit of the liquid crystal display device in FIG. 11. The liquid crystal display device 1100 comprises pixels, data lines 1110 and first switches 1140. The pixels use to display gray-scale signals in an image, each of the data lines 1110 is used to transmit data signals to each of the pixels, and each of the first switches 1140 is used to control each of the pixels to be switched on. Each of the pixels comprises a main-pixel 1120 used to display main-gray-scale signals and a sub-pixel 1130 used to display sub-gray-scale signals. The liquid crystal display device 1100 further comprises a pair of pixel capacitors C1 and C2 and second switches 1150. When each of the second switches 1150 is switched on, the main-pixel 1120 and the sub-pixel 1130 are turned on by the pair of pixel capacitors C1 and C2, so that potentials of the main-pixel 1120 and the sub-pixel 1130 may redistribute in accordance with a ratio of values of the two capacitors. Finally, a voltage of the main-pixel 1120 and a voltage of the sub-pixel 1130 forms a voltage-relationship, and thus the two pixels attain different optical properties for performing a wide viewing angle in displaying.

For reducing the crosstalk phenomenon, the liquid crystal display device 1100 of this invention further comprises a control unit (not shown in Figs.) and third switches 1160, wherein each of the third switches 1160 is used to control the main-pixel 1120 to be switched on. The liquid crystal display device further comprises what the control unit is connected to a control terminal of the third switch 1160 via scan lines G3 for controlling the third switches 1160 to be switched on. An input terminal of the third switch 1160 is connected to a fixed voltage terminal, and an output terminal of the third switch 1160 is connected to the main-pixel 1120. The fixed voltage terminal is used to provide a fixed voltage signal, and the best choice of the fixed voltage signal is a common signal (COM).

Please simultaneously refer to FIGS. 7, 11 and 12, when using the liquid crystal display device 1100 of this invention to display a 2D image, because of what having not to concern about the occurring crosstalk phenomenon, the third switch 1160 has been cut off, and thus the fixed voltage signal may not be transmitted to the main-pixel 1120 via the third switch 1160. During displaying the 2D image, the first switches 1140 are switched on first (controlled by scan lines G1) for transmitting signals of the data lines 1110 to the main-pixel 1120 and the sub-pixel 1130, and then connecting the second switches 1150 (controlled by scan lines G2); thus redistributing a driving voltage between the main-pixel 1120 and the sub-pixel 1130 by the corresponding pixel capacitors C1 and C2. An on-time of the first switch 1140 is within a high voltage signal of the data line 1110, and this may ensure that 2D image signals can be normal displayed and the gray-scale signals of the main-pixel 1120 and the gray-scale signals of the sub-pixel 1130 show the different gray-scale-signal driving voltage in accordance with the pixel capacitors C1 and C2 for achieving a better performance in displaying. The main-pixel 1120 and the sub-pixel 1130 may normally display the 2D image as a traditional liquid crystal display device, so that the two pixels attain different optical properties for performing the wide viewing angle in displaying.

Please simultaneously refer to FIGS. 11, 12 and 13, when using the liquid crystal display device 1100 of this invention to display a 3D image, the third switch 1160 is kept to be switched on and the common signals may be transmitted to the main-pixel 1120 by the third switch 1160. At this time, it is equal to produce black-matrix signal at a position of the main-pixel 1120, and the black-matrix signal may not be affected by the gray-scale signals of the sub-pixel 1130 and may realize the black-matrix signal with whole black for really attaining the target in reducing the crosstalk phenomenon. During displaying the 3D image, when the data lines 1110 transmit 3D gray-scale signals, the first switches 1140 and the second switches 1150 are switched on, and the main-pixel 1120 and the sub-pixel 1130 normally display image signals. After the data lines 1110 transmitted the 3D gray-scale signals, the first switches 1140 and the second switches 1150 are cut off, and the third switches 1160 are connected (controlled by the scan lines G3). Thus, the main-pixel 1130 displays the black-matrix signal for realizing the black-matrix signal with whole black, which perform to the liquid crystal display device is what the main-pixel 1130 has appeared the dark state. By distinguishing the black-matrix signal and the gray-scale signals may reduce the crosstalk phenomenon, thus the liquid crystal display device 1100 of this invention can be good in reducing the crosstalk phenomenon during displaying the 3D image and may not affect brightness during displaying the 2D image.

In summary, when the present invention has been described in terms of a preferred embodiment thereof, it is to be understood that the invention is not limited thereto. Other skilled in this art may change and modification to the described embodiment without departing from the true scope and the spirit of the invention that is intended to be limited only by the appended claims.

What is claimed is:

1. A liquid crystal display device, comprising: pixels to display gray-scale signals of an image, data lines to transmit data signals to the pixels, and first switches to control the pixels to be switched on;
wherein each of the pixels comprises: a main-pixel to display main-gray-scale signals and a sub-pixel to display sub-gray-scale signals, and the liquid crystal display device further comprises: a pair of pixel capacitors to redistribute voltages of the main-gray-scale signals of the main-pixel and the sub-gray-scale signals of the sub-pixel in the same frame of image; and a second switch to control the redistribution operation, characterized in that:
the liquid crystal display device further comprises a third switch to control the sub-pixel to be switched on; and
the liquid crystal display device further comprises: a control unit which controls the third switch to be switched on, the control unit is connected to a control terminal of the third switch, an input terminal of the third switch is connected to a black-matrix signal, and an output terminal of the third switch is connected to the sub-pixel;
wherein when the liquid crystal display device displays a 3D image, the third switch is kept to be switched on;
wherein when the liquid crystal display device displays a 2D image, the third switch is kept to be switched off; and
wherein, the black-matrix signal is a common signal.

2. A liquid crystal display device, comprising: pixels to display gray-scale signals of an image, data lines to transmit data signals to the pixels, and first switches to control the pixels to be switched on;
wherein each of the pixels comprises: a main-pixel to display main-gray-scale signals and a sub-pixel to display sub-gray-scale signals, and the liquid crystal display device further comprises: a pair of pixel capacitors to redistribute voltages of the main-gray-scale signals of the main-pixel and the sub-gray-scale signals of the sub-pixel in the same frame of image; and a second switch to control the redistribution operation, characterized in that:
the liquid crystal display device further comprises a third switch to control the sub-pixel to be switched on.

3. The liquid crystal display device according to claim 2, characterized in that: a control terminal of the first switch is connected to a scan line, an input terminal of the first switch is connected to one of the data lines, and an output terminal of the first switch is connected to the main-pixel and the sub-pixel, respectively.

4. The liquid crystal display device according to claim 2, characterized in that: the liquid crystal display device further comprises: a control unit to control the third switch to be switched on, wherein the control unit is connected to a control terminal of the third switch, an input terminal of the third switch is connected to the black-matrix signal, and an output terminal of the third switch is connected to the sub-pixel.

5. The liquid crystal display device according to claim 4, characterized in that: when the liquid crystal display device displays a 3D image, the third switch is kept to be switched on.

6. The liquid crystal display device according to claim 4, characterized in that: when the liquid crystal display device displays a 2D image, the third switch is kept to be switched off.

7. The liquid crystal display device according to claim 4, characterized in that: the black-matrix signal is a common signal.

8. A liquid crystal display device, comprising: pixels to display gray-scale signals in an image, data lines to transmit data signals to the pixels, and first switches to control the pixels to be switched on;
wherein each of the pixels comprise: a main-pixel to display main-gray-scale signals and a sub-pixel to display sub-gray-scale signals, and the liquid crystal display device further comprises: a pair of pixel capacitors to redistribute voltages of the main-gray-scale signals of the main-pixel and the sub-gray-scale signals of the sub-pixel in the same frame of image; and a second switch to control the redistribution operation, characterized in that:
the liquid crystal display device further comprises a third switch to control the main-pixel to be switched on.

9. The liquid crystal display device according to claim 8, characterized in that: a control terminal of the first switch is connected to a scan line, an input terminal of the first switch is connected to one of the data lines, and an output terminal of the first switch is connected to the main-pixel and the sub-pixel, respectively.

10. The liquid crystal display device according to claim 8, characterized in that: the liquid crystal display device further comprises: a control unit which controls the third switch to be switched on, wherein the control unit is connected to a control terminal of the third switch, an input terminal of the third switch is connected to a black-matrix signal, and an output terminal of the third switch is connected to the main-pixel.

11. The liquid crystal display device according to claim 10, characterized in that: when the liquid crystal display device displays a 3D image, the third switch is kept to be switched on.

12. The liquid crystal display device according to claim 10, characterized in that: when the liquid crystal display device displays a 2D image, the third switch is kept to be switched off.

13. The liquid crystal display device according to claim 10, characterized in that:
the black-matrix signal is a common signal.
